(19) United States
(12) Patent Application Publication
(10) Pub. No.: US 2026/0087644 A1
(43) Pub. Date: Mar. 26, 2026

(54) OBJECT REPRESENTATION VIA STATE DIAGRAMS FOR OBJECT DETECTION AND TRACKING

(71) Applicant: QUALCOMM Incorporated, San Diego, CA (US)

(72) Inventors: Varun RAVI KUMAR, San Diego, CA (US); Kiran BANGALORE RAVI, Paris (FR); Senthil Kumar YOGAMANI, San Diego, CA (US)

(21) Appl. No.: 18/895,133

(22) Filed: Sep. 24, 2024

(51) Int. Cl. G06T 7/246; G06V 10/82

(52) U.S. Cl. CPC G06T 7/246; G06V 10/82; G06T 2207/10016; G06T 2207/10028; G06T 2207/20081; G06T 2207/20084

(57) ABSTRACT

The present disclosure provide techniques for objection detection and tracking. A method may include obtaining a first frame, associated with a first time point, the first frame comprising a plurality of points corresponding to one or more first objects in a scene at the first time point; obtaining a final state diagram comprising a respective final time series sequence of predicted object states, for each second object of one or more second objects, associated with a first plurality of time points prior to the first time point or after the first time point; and processing the first frame and the final state diagram to detect the one or more first objects in the scene at the first time point.

### INTRODUCTION

### Field of the Disclosure

Aspects of the present disclosure relate to techniques for objection detection and tracking.

### Description of Related Art

Object tracking is an important computer vision task that aims to estimate the trajectory(ies) of one or more objects of interest (e.g., cars, pedestrians, bicycles, etc.) across successive frames. The objective of object tracking is to maintain a consistent association between an object and its representation across different frames, despite changes in position, scale, orientation, and/or appearance, including when the object temporarily disappears from view and/or becomes obscured. Object tracking may include two-dimensional and three-dimensional (3D) object tracking. While 2D object tracking operates to track object(s) based on individual image frames, 3D object tracking is based on identifying and monitoring object(s) in a 3D environment based on spatial and temporal information present in 3D data representations (e.g., such as point cloud sequences). Object tracking, including 2D and/or 3D object tracking, is fundamental in various applications, including autonomous driving, robot navigation, augmented reality, security and surveillance, and human computer interaction, to name a few.

Although object tracking has been studied for several decades, and much progress has been made in recent years, object tracking remains a technically challenging task, particularly with respect to detecting and tracking occluded and long objects.

For example, some object tracking systems may struggle when object(s) become occluded in a frame (e.g., of a sequence of frames). Occlusions can occur in various forms, such as partial occlusions where only a portion of an object is blocked from view, or full occlusion where an entire object is hidden for a period of time (e.g., for one or more frames of the sequence of frames). Occlusions often disrupt the continuity of an object's track (e.g., over the sequence of frames), leading to identity switches or track interruptions. As used herein, a “track” may refer to a temporal sequence of detections associated with a single object over multiple frames, generally representing the entire trajectory of the object. A “detection” may refer to the identification and localization of an object or object state (e.g., velocity, size, orientation, heading, semantic class, etc.), which may be represented by various data types, such as bounding boxe(es), point(s), cluster(s), and/or the like (e.g., such as depending on sensor modality and/or the specific application for the object tracking). For example, when an object is occluded, a tracking system may lose track of the object's identity and thus, assign the object a new identifier for tracking when it reappears. This may lead to fragmented tracks being associated with the same object.

Long objects also pose challenges for accurate localization due to their generally limited visibility and sparse point cloud representation. As used herein, a long object may refer to an object characterized by its elongated shape and large spatial extent. In particular, challenges with tracking long objects may include accurately tracking the entire length of a long object through occluded region(s) and maintaining consistent identification throughout. As an illustrative example, a truck with a trailer may represent a single long object in a scene captured by a sequence of frames over a period of time. Although the truck-trailer ensemble represents a single object and the truck and trailer are moving together in the scene, a first tracklet representing a trajectory of the truck over the period of time may be created separately from a second tracklet representing a trajectory of the trailer over the period of time. Thus, the truck-trailer ensemble (e.g., an example long object) may be associated with two or more unassociated tracklets due to its susceptibility to occlusions when performing object tracking. Unassociated tracklets created for a same long object may lead to insufficient tracking for such long objects. While a “track” may generally represent the entire trajectory of a single object, a “tracklet” may represent a portion of the track, for example, a “tracklet” may represent a short track (e.g., such as over a few frames) for the object.

In some applications, such as autonomous driving and/or video surveillance, maintaining accurate and consistent object identities may be important for decision making and/or scene understanding. Fragmented and unassociated tracklets created for occluded and/or long objects, caused by occlusions and sparse data representation, may lead to incorrect analysis and, in some cases, potentially dangerous situations.

### SUMMARY

One aspect provides a method for objection detection and tracking. A method may include obtaining a first frame, associated with a first time point, the first frame comprising a plurality of points corresponding to one or more first objects in a scene at the first time point; obtaining a final state diagram comprising a respective final time series sequence of predicted object states, for each second object of one or more second objects, associated with a first plurality of time points prior to the first time point or after the first time point; and processing the first frame and the final state diagram to detect the one or more first objects in the scene at the first time point.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1A depicts an example workflow for encoding and processing of object information, particularly across temporal frames, for object detection and tracking.

FIGS. 1B and 1C depict example final state diagrams.

FIG. 1D depicts example final state diagram generation using forward motion forecasting.

FIG. 1E depicts example final state diagram generation using reverse motion forecasting.

FIG. 2 depicts an example method for object detection and tracking.

FIG. 3 depicts an example sensor and computing system.

FIG. 4 depicts aspects of an example apparatus.

### DETAILED DESCRIPTION

Aspects of the present disclosure provide apparatuses, methods, processing systems, and computer-readable mediums for objection detection and tracking. For example, aspects described herein provide improved techniques for object detection, such as for object(s) in a first frame, which leverage motion forecasting outputs captured in a state diagram that has a graph-based structure, such as a graph neural network (GNN). That is, the state diagram, including the motion forecasting outputs, may serve as supplementary data to point cloud data of the first frame, which may be provided to a multi-modal object detector (e.g., a machine learning (ML) model) for object detection for the object(s) in the first frame.

In some cases, point cloud sequence data has proven helpful in overcoming the technical challenges associated with object detection and tracking, such as for occluded and long objects, as described above. A point cloud is a collection of points (e.g., associated with objects) in 3D space for a surveyed (e.g., scanned) environment. Each “point” included in a point cloud may refer to a data point in a 3D coordinate system representing a single spatial measurement on an object's surface in the scene. For example, each point may be expressed as a set of x, y, and z coordinates. 3D sensor(s), such as light detection and ranging (LiDAR) sensor(s), may be used to produce point clouds.

A “point cloud sequence” may refer to a series of frames of 3D point clouds captured over a period of time. For example, a point cloud sequence may provide a “video” of 3D data where each frame is a snapshot of a point cloud, representing a scene and/or object from different perspectives and/or at different moments. The ability of a point cloud sequence to capture different viewpoints of object(s) in a scene may help to improve visibility of the object(s) over time. Thus, object detection and tracking, in the presence of challenging conditions such as occlusions, may be improved.

While utilization of point cloud sequences for object detection and tracking provide the aforementioned technical advantages, techniques that rely on point cloud sequences may struggle with efficiently encoding long-term sequence data to effectively leverage the data for object detection and tracking. Additionally, solely relying on temporal features, provided via a point cloud sequence, may not adequately enhance object detection and tracking performance.

For example, multiple frame, object detection techniques may fuse together point cloud sequence data at either (1) a scene level or (2) an object level. Specifically, at the scene level, multiple frame, object detection techniques may transform point clouds of different frames to a target frame using known ego motion poses (e.g., change in pose of an image sensor, used to generate the point clouds, in relation to a rigid scene). Each point may be augmented with an extra time channel to indicate which frame corresponds to the respective point (e.g., indicating the frame that the respective point is from). The merged points may then be fed to deep neural networks. Due to resource constraints (e.g., memory and/or computational resource constraints), however, such techniques may be difficult to scale up, such as to process additional frames. For example, a technical problem of such techniques includes the large computational overhead that may result from including more input frames to improve the object detection. Further, as another technical problem of such techniques, temporal data fusion at the scene level may be ineffective, especially for moving objects.

Object detection techniques that fuse together point cloud sequence data at the object level, on the other hand, may provide a more tractable solution than object detection at the scene level, given significantly less points may need to be processed/fused for a single object than for points associated with multiple objects in a scene. This may allow for longer temporal contexts to be aggregated for object detection. However, in some cases, object detection at the object level may also fail to scale up temporal context aggregation to longer point clouds sequences due to efficiency issues and/or alignment challenges.

To overcome the aforementioned technical problems associated with multiple frame, object detection and tracking (e.g., including the inefficiency and lack of effectiveness in encoding long-term sequence data), some other techniques propose to use motion forecasting outputs, as a type of virtual modality, to augment point clouds for object detection and tracking.

For example, motion forecasting may be used to propagate object information from the past to a target frame or from the future to a target frame. The output of the forecasting may generate a set of virtual points, one for each object from a waypoint on a forecasted trajectory. Each virtual point may be associated with one or more object states. Example object states associated with a virtual point may include a predicted object location of the respective virtual point in the target frame, an object type of the object associated with the respective virtual point, an object size of the object associated with the respective virtual point, a heading predicted for the respective virtual point, and/or the like. Multiple virtual points, associated with the target frame, may be fused with raw point cloud data and provided as input into an object detector, such as an ML model (e.g., a deep learning neural network), for object detection (and subsequently object tracking). For example, objects states associated with the virtual points and the raw point cloud data may be encoded as channels within the ML model.

As used herein, a “channel” may refer to a separate stream or layer of information within the input data for an ML model, which may represent a specific feature or aspect of the data. Each channel may hold values corresponding to a particular attribute or state of an object (e.g., such as object type, size, or location). The number of channels may correspond to the distinct types of information that are being processed simultaneously by the ML model (e.g., within the neural network).

The encoding of channels may depend on how an ML model is structured and/or how the ML model processes object states. For example, in certain aspects, each unique object state (e.g., object type, size, location, etc.) may have its own channel. Thus, shared object types, such as object type, between two points may be encoded in a single channel across the points. For example, a first point may be associated with an object type and a location. A second point may be associated with an object size and a location. Thus, three channels in total may be used: one channel for the object type, one channel for the location (e.g., shared among the two points), and one channel for the object size. Each channel may hold values corresponding to the particular object state associated with the respective channel.

As another example, in certain other aspects, the encoding may assign a unique channel per object state (e.g., feature) for each point, meaning every object state for each object point may be associated with its own channel. For example, a first point may be associated with an object type and a location. A second point may be associated with an object size and a location. Thus, four channels in total may be used: one channel for the object type (first point), one channel for the location (first point), one channel for the location (second point), and one channel for the object size (second point).

In either example, the ML model may process the channels to make predictions, such as for objection detection and tracking.

As used herein, motion forecasting may refer to a process of predicting the location and movement of a tracked object. Motion forecasting may involve perceiving where an object is in the world, such as at different time points, and predicting a location of the object at a different time point. Prediction of the object's location in a target future frame based on past detections/observations of the object in past frames may be referred to herein as “forward motion forecasting.” Alternatively, prediction of the objection's location in a target past frame based on detections/observation of the object in frames associated with time points later in time than the target past frame (e.g., “future frames”) may be referred to herein as “reverse motion forecasting.”

Object detection and tracking based on point cloud points and motion forecasted virtual points may provide various beneficial technical effects and/or advantages over other techniques, such as those techniques described above that rely on multiple frame, object detection and tracking techniques. For example, fusing motion forecasting output with other sensor modalities, such as points clouds created via LiDAR sensor(s), may help to achieve more robust object detection, especially for occluded (e.g., low visibility) objects and/or long objects. For example, such techniques may help to maintain accurate tracking and motion prediction of an object, even during occlusion, at least due to the motion forecasting.

A technical problem, however, associated with such techniques involves encoding each of the object states as a channel for the ML model to process. Specifically, the ML model may learn interactions between different object states (e.g., channels) through convolutional or sequential processing, which may not fully capture the complex dependencies between object states. This incomplete understanding, in some cases, may adversely affect the ML model's ability to accurately perform object detection.

In certain aspects, the use of channels within convolutional layers of the ML model may be effective for processing spatial features in point clouds and/or images, but may often lack the depth needed for relational learning, which may be important for object detection and tracking in dynamic environments (e.g., another technical problem associated with techniques for object detection using motion forecasting). Relational learning may refer to an ML model's ability to capture interactions and/or dependencies between objects, such as how one object's movement influences another. This may be important for tasks like motion forecasting, where an understanding of such relationships may help to improve prediction. Traditional channels emphasize individual object features (e.g., such as size, type, location, etc.), but they may not effectively model how objects interact over time, thereby limiting the ML model's ability to handle complex, dynamic scenes.

As another technical problem, encoding each of the object states as channels for processing by the ML model may result in inefficient processing of data by the ML model for objection detection and tracking. That is, the channel-based approach may process all encoded object states (e.g., channels) equally, which may result in a fixed computational cost irrespective of the relevance of specific data points for accurate object detection and tracking. Inability of the ML model to selectively focus on specific object states (e.g., such as by applying different weights) over other object states may decrease the efficiency of the ML model, at least in some cases. Further, as the number of frames and/or object states (e.g., channels) increases, the computational cost may grow significantly, potentially limiting the scalability of this approach in handling large temporal sequences and/or complex scenes.

Certain aspects described herein overcome the aforementioned technical problems associated with current object detection techniques and provide a technical benefit to the field of computer vision. Specifically, aspects described herein provide improved techniques for object detection and tracking, such as of first object(s) included in a first frame, which leverage motion forecasting outputs captured in a final state diagram. For example, a sequence of past (e.g., historical) or future frames with respect to the first frame, may be partitioned into multiple time series subsequences of frames. Motion forecasting may be used to predict object states for one or more respective objects at a respective target frame for each time series subsequence of frames. The predicted object states associated with each time series subsequence of frames may be captured in a respective state diagram associated with the respective time series subsequence of frames. The predicted object states determined for each of the time series subsequences of frames may be concatenated, such that each state diagram associated with each time series subsequence of frames is integrated to create a final state diagram. The final state diagram and the first frame may be processed together to detect the first object(s) in the first frame. For example, the final state diagram may serve as supplementary data to point cloud data of the first frame, which may be provided to a multi-modal object detector (e.g., a ML model) for object detection at the first frame. Further, in certain aspects, the final state diagram and the point cloud data of the first frame may be unionized and used to train the multi-modal object detector.

In certain aspects, the final state diagram, and each respective state diagram, is a graph neural network (GNN). A GNN is an ML model that uses deep learning to analyze data presented as a graph. A graph is a structure made up of nodes (also referred to as “vertices”), which are connected by edges (also referred to as “links”). For example, an edge connecting two nodes of a graph may represent an existing relationship between the two nodes. GNNs are designed to process the graph data to analyze the relationships between data points, represented as nodes and edges in a graph, such as to make predictions and/or solve problems. The final state diagram, described herein and represented as a GNN, may analyze a graph including multiple nodes, where each node represents a predicted object state, such as predicted during motion forecasting. Edges between nodes in the graph of the GNN may capture the relationships between different objects and their respective (predicted) object states over time. The GNN, when analyzing the graph structure, may propagate information across the nodes (e.g., representing different predicted object states), to allow the network to learn and/or understand complex temporal and spatial dependencies that may exist among different objects and/or their respective object states.

A respective state diagram associated with a time series subsequence of frames may similarly comprise a respective GNN. A GNN created for the time series subsequence of frames may propagate object states for objects associated with the time series subsequence of frames to predict object states at a target frame. The GNN may capture and analyze relationships between each of these object states in a graph, thereby contributing to improved understanding of relationships between objects and their object states, such as for improved motion forecasting (e.g., object state prediction). Use of GNNs, as described herein, may outperform channel-based methods, which often require processing redundant information without considering object relationships.

Utilizing historical frames or future frames to generate a final state diagram, such as a GNN, provides a mechanism for capturing temporal dynamics of objects in a scene for improved object detection and tracking performance, such as object detection and tracking for object(s) in the first frame. For example, in certain aspects, the motion prediction included in the final state diagram may be used to help to extrapolate the likely path(s) of occluded object(s) in the scene, thereby helping to enable smoother track transitions and/or reducing the likelihood of track fragmentation for such object(s). This may help to provide more robust and consistent tracking of object(s), particularly in scenarios with frequent occlusions. As another example, by leveraging the final state diagram including predicted motion information for one or more objects in the scene, the positions and/or orientations of long objects may be more accurately estimated, thereby compensating for the inherent uncertainty associated with sparse point cloud data. In certain aspects, this may lead to more accurate localization and/or improved tracking performance for object(s) at a distance. As another example, by leveraging the final state diagram including predicted motion information for one or more objects in the scene, the future object states of long object(s) may be more accurately estimated, which may help to enable proactive adjustments to tracklet trajectories and/or help to reduce the accumulation of tracking errors. As such, more reliable and consistent tracklets may be realized, even for object(s) with sparse and distant observations. Accordingly, leveraging the final state diagram for object detection tracking may beneficially enable the anticipation of object motion, improve localization accuracy, and/or maintain track consistency in dynamic environments, thereby enhancing the overall performance of object detection and tracking systems.

While many conventional techniques may rely on point cloud-based representations and/or traditional deep learning architectures, as described above, the final state diagram, described herein, introduces a graph-based representation for predicted object states encoding. This may allow for more efficient encoding and processing of object information, particularly across temporal frames, when performing object detection (e.g., via an ML model) and tracking. Specifically, the final state diagram may provide a lightweight alternative to techniques that may rely on point cloud-based temporal data fusion. With significantly fewer elements compared to point clouds, leveraging the final state diagram may enable the inclusion of information from numerous context frames, which may enhance object detection and tracking performance in dynamic environments. For example, some techniques may consider temporal information for up to ten point clouds for object detection and tracking, whereas, with the use of the final state diagram, as a non-limiting example, up to 300 historical and/or future frames may be used to capture temporal dynamics of object(s) in a scene for improved object detection and tracking.

### Example Workflow for Object Detection and Tracking

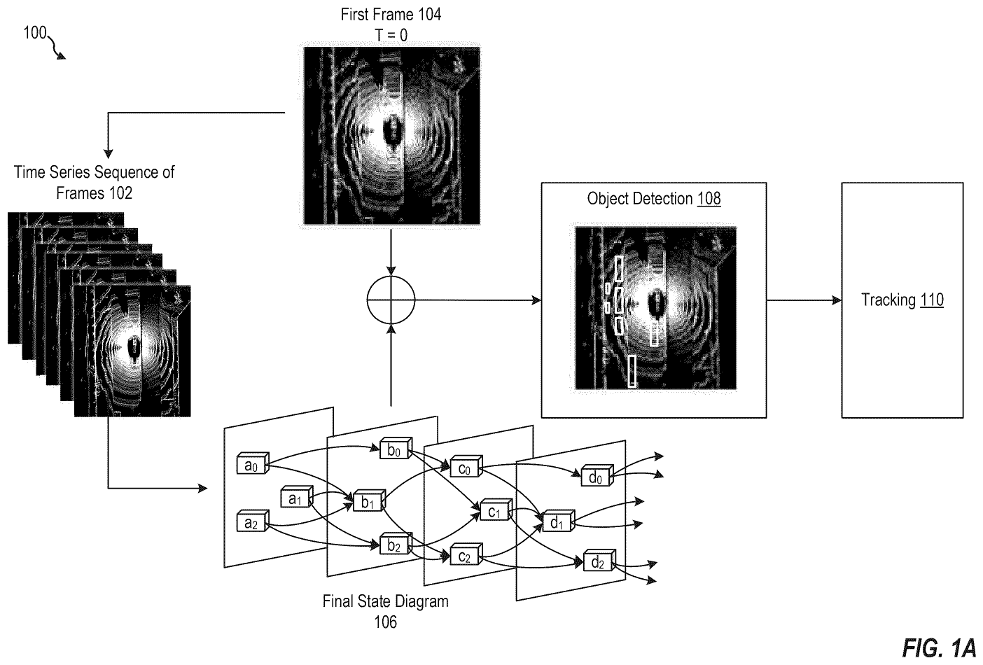

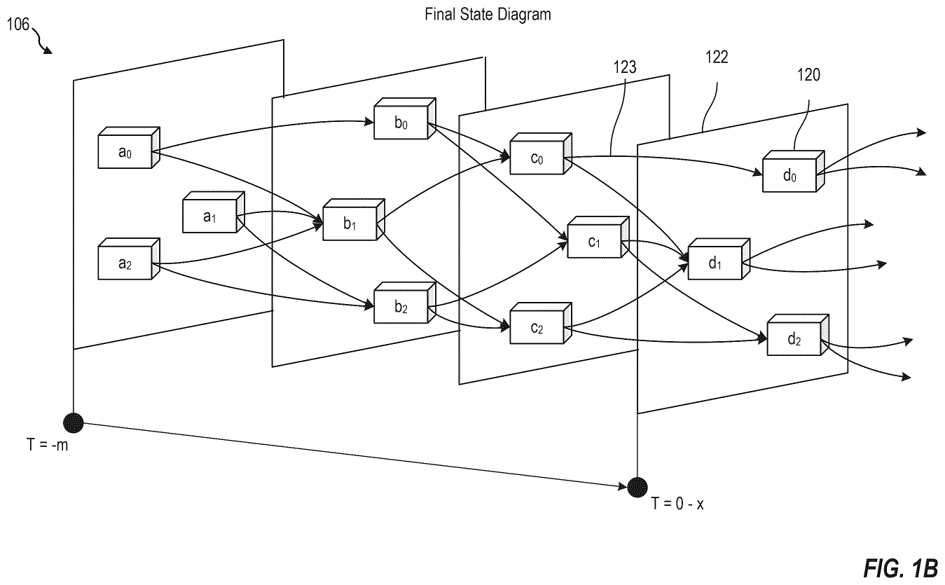

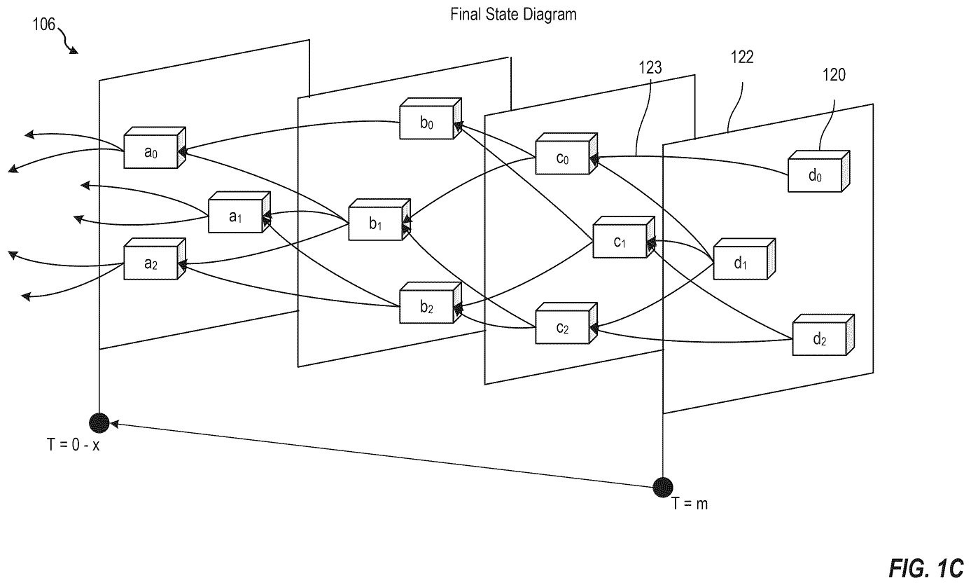

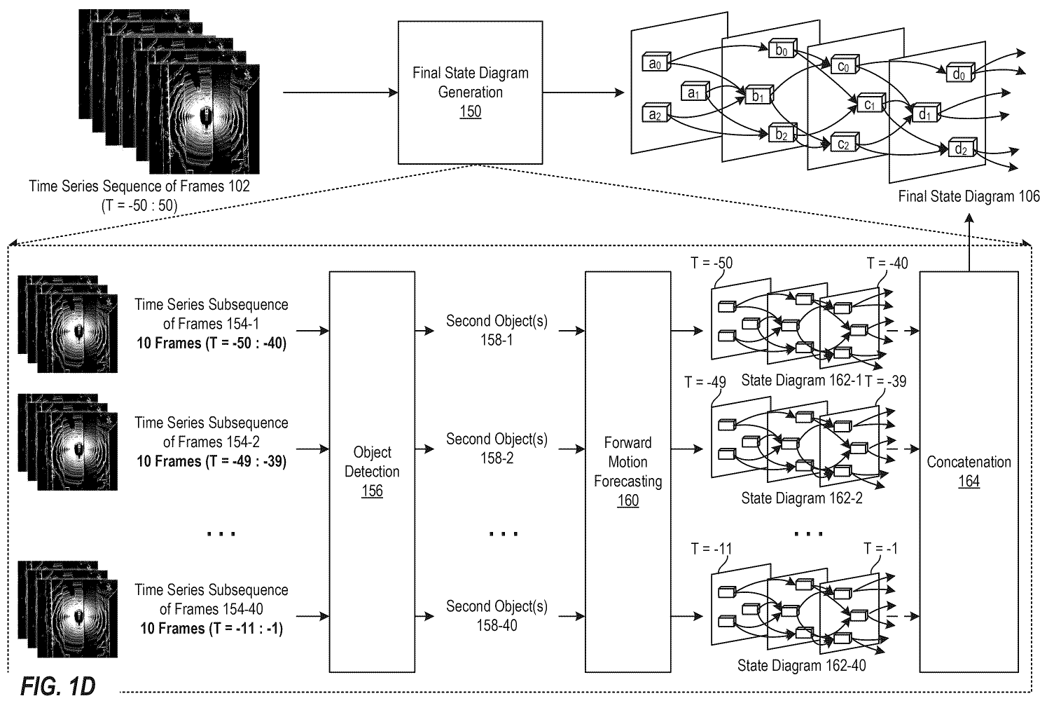

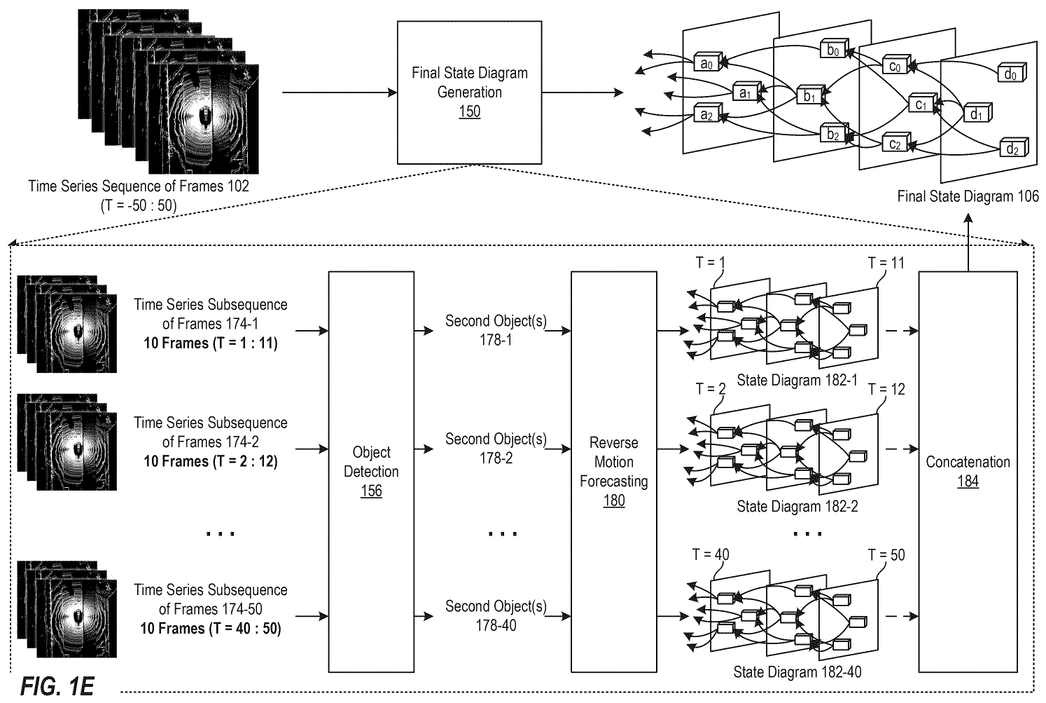

FIG. 1A depicts an example workflow 100 for encoding and processing of object information, particularly across temporal frames, for object detection and tracking. For example, workflow 100 may be used to perform object detection and tracking for objects included in a first frame 104, according to aspects described herein.

The first frame 104 may capture one or more first objects in a scene, such as a dynamic real-world scene (e.g., a scanned environment), at a first time point (e.g., time T=0). For example, the first frame 104 may include depictions of the one or more first objects in the scene at the first time point. In certain aspects, the one or more first objects may include long object(s), object(s) occluded by other object(s), and/or other types of object(s) in the scene at the first time point.

In certain aspects, the first frame 104 may comprise a 3D frame or a 3D representation, such as a 3D point cloud (simply referred to herein as “a point cloud”). For example, a 3D sensor, such as LiDAR sensor, may be used to produce the point cloud of the first frame 104. The point cloud of the first frame 104 may include a collection of points (e.g., associated with one or more objects) in 3D space for the scene. In certain aspects, the first frame 104 comprises a sparse point cloud (e.g., including a limited amount of points). Although aspects herein are described with respect to the first frame 104 comprising a point cloud, in certain other aspects, other frame data may be considered. For example, in certain other aspects, the first frame 104 may comprise a 2D frame or 2D representation, such as a 2D image. For example, an image sensor, such as a camera, may be used to produce the 2D image of the first frame 104. The 2D image of the first frame may include pixels in 2D space for a scanned environment.

To perform object detection 108 (and subsequently tracking 110) for object(s) in first frame 104, workflow 100 may process both points from the point cloud of the first frame 104 and a final state diagram 106. For example, workflow 100 may augment the points from the point cloud of the first frame 104 with information included in the final state diagram 106, and provide this augmented information to a multi-model object detector for objection detection 108.

Information included in the final state diagram 106 may include a time series sequence of predicted object states for one or more second objects detected in a time series sequence of frames 102. That is, workflow 100 may use the time series sequence of frames 102 to generate the final state diagram 106. The one or more second objects may represent objects that are captured in the time series sequence of frames 102. In certain aspects, the second object(s) may include the first object(s) captured in first frame 104. In certain aspects, the second object(s) may include at least one second object that is occluded (partially or fully) in the first frame 104. In certain aspects, the second object(s) may include at least one second object that is not captured in first frame 104. For example, at least one second object may not be captured in the first frame 104 as a first object because it is fully occluded in the first frame 104.

In certain aspects, the time series sequence of frames 102 may include frames associated with time points (e.g., T=[−m, 0−x]) prior in time to the first time point (e.g., T=0) associated with the first frame 104. In certain other aspects, the time series sequence of frames 102 may include frames associated with time points (e.g., T=[0+x, m]) later in time than the first time point (e.g., T=0) associated with the first frame 104.

In certain aspects, the time series sequence of frames 102 may include two or more frames, such as a sequence of frames from a video, frames from the scene captured by LIDAR sensor, fused frames combining information from multiple sensors, and/or any other suitable type of frame data. In certain aspects, the time series sequence of frames 102 may be obtained from various sources, such as video sequences captured by cameras, frames from a scene provided by a LIDAR sensor, etc. In certain aspects, fused frames, also referred to as “fused sensor data,” may leverage data from both LIDAR sensor(s) and image sensor(s) (e.g., camera(s)), where at least one LIDAR sensor provides depth information, while at least one image sensor provides visual details for the scene.

In certain aspects, the time series sequence of frames 102 may include 3D frames or 3D representations, such as point clouds. In certain other aspects, the time series sequence of frames 102 may include 2D frames or 2D representations, such as 2D images.

The time series sequence of frames 102 may include the second object(s) (as in depictions of the second object(s)). The second object(s) may include object(s) detected in the scene over a time period from T=[−n, 0−x] or from T=[0+x, n] where n>m. The second object(s) may include long object(s), object(s) occluded by other object(s), and/or other types of object(s) in the scene over the time period. The number of frames included in the time series sequence of frames 102 may be based on a temporal resolution of the frames (e.g., the time period between each frame in the time series sequence of frames 102). Thus, the set of frames 102 may include multiple non-adjacent frames (e.g., frames that are associated with time points that are each separated by a period of time).

In certain aspects, the temporal context window of the time series sequence of frames 102 may be adjusted, such as to adjust the number of historical or future frames used for object detection 108. For example, in certain aspects, the temporal context window of the time series sequence of frames 102 may be increased (e.g., increased to include frames associated with T=−70 to T=70 instead of frames associated with T=−50 and T=50). Increasing the temporal context window may help to improve the object detection performance for the first frame 102, given a longer sequence of frames may be leveraged via workflow 100.

In certain aspects, final state diagram 106 is a graph-based structure, and each predicted object state (e.g., for second object(s) detected in the time series sequence of frames 102) included in the final state diagram 106 may be represented as a node in the graph-based structure. Each predicted object state (e.g., node) may be associated with a single second object of the one or more second objects. Each predicted object state (e.g., node) may be associated with a time point of a frame included in the final state diagram 106. Relationships between nodes (e.g., the predicted object states) over the period of time represented by the frames included in the final state diagram may be established, such as to indicate relationships between predicted object states for the second object(s) over the period of time.

For example, in certain aspects, final state diagram 106 includes predicted object states for second object(s) detected in the time series sequence of frames 102, where the time series sequence of frames 102 includes frames prior in time to the first frame 104 (e.g., associated with the time period from T=[−n, 0−x]). The final state diagram 106 may include predicted object states for the second object(s) for time points between and including time T=[−m, 0−x], where m<n, such as shown in FIG. 1B. The final state diagram 106, shown in FIG. 1B, includes nodes 120 associated with different frames 122 corresponding to different time points. Each node 120 represents predicted object state(s) for a second object at a time point of the frame 122 associated with the respective node 120. For example, node d₀ may include information about object state(s) predicted for a first object at time T=0−x, node d₁ may include information about object state(s) predicted for a second object at time T=0−x, and node d₂ may include information about object state(s) predicted for a second object at time T=0−x. Relationships between nodes 120, or object states, may be represented via edges 123 in the final state diagram 106 in FIG. 1B. In certain aspects, the edges may represent the propagation of second object(s)'s states over the time period from T=−m to T=0−x represented by the final state diagram 106 in FIG. 1B (e.g., such as shown by the right-pointing arrows in FIG. 1B).

In certain other aspects, final state diagram 106 includes predicted object states for second object(s) detected in the time series sequence of frames 102, where the time series sequence of frames 102 includes frames later in time than the first frame 104 (e.g., associated with the time period from T=[0−x, n]). The final state diagram 106 may include predicted object states for the second object(s) for time points between and including time T=[0−x, m], where m<n, such as shown in FIG. 1C. Similar to FIG. 1B, the final state diagram 106, shown in FIG. 1C, includes nodes 120 associated with different frames 122 corresponding to different time points. Each node 120 represents predicted object state(s) for a second object at a time point of the frame 122 associated with the respective node 120. Relationships between nodes 120, or object states, may be represented via edges 123 in the final state diagram 106 in FIG. 1C. In certain aspects, the edges may represent the propagation of second object(s)'s states over the time period from T=m to T=0−x represented by the final state diagram 106 in FIG. 1C (e.g., such as shown by the left-pointing arrows in FIG. 1C).

In certain aspects, final state diagram 106 is a GNN used to analyze a graph including the nodes 120 and edges 123 shown in FIG. 1B or FIG. 1C. This structured representation may allow for efficient encoding and processing of object information for the second object(s) across temporal frames, such as for object detection 108 in FIG. 1A.

Example predicted object states associated with a second object and predicted for a particular time point (e.g., included in final state diagram 106) may include a size of the second object at the particular time point; a location of the second object in a scene at the particular time point; an orientation of the second object at the particular time point; a pose estimation (e.g., detailed pose information, such as joint angles or body orientation in the case of human and/or animal tracking) of the second object at the particular time point; one or more shape descriptors (e.g., descriptors or features that capture the aspect ratio, elongation, curvature, etc.) associated with the second object at the particular time point; one or more visual features (e.g., an appearance) of the second object at the particular time point; a velocity of the second object at the particular time point (e.g., including angular velocity); an acceleration of the second object at the particular time point; a heading of the second object at the particular time point (e.g., such as expressed as a unit vector indicating the second object's orientation); a semantic class (e.g., classification of the object type, such as pedestrian, vehicle, cyclist, etc., which, in some cases, may be encoded using one-hot encoding with a depth of 3) associated with the second object at the particular time point; a semantic class confidence score (e.g., a measure of the confidence in the classification of the semantic class); a trajectory score (e.g., a measure of the confidence associated with a predicted object trajectory, such as a confidence level, which in some cases may be over a past or future number of frames) associated with the second object at the particular time point; one or more confidence scores indicating a reliability of the predicted object state; a trajectory standard deviation (e.g., which may provide insight into trajectory uncertainty); time elapsed since a last detection of the object (e.g., such as in a prior frame of the time series sequence of frames 102); dynamic(s) of the scene; an occlusion state of the second object at the particular time point (e.g., indicating whether the second object is currently occluded and/or the extent of the occlusion, such as partial or full occlusion); one or more interaction features (e.g., features indicating interaction with other objects or agents in the scene, such as proximity of the second object to other objects at the particular time point, predicted collision course, etc.); an environmental context (e.g., information about the environment around the second object, such as a road type, weather conditions, etc.); an appearance change rate (e.g., the rate at which the appearance of the second object changes over time, such as due to lighting changes, deformation, etc.); a measure of a consistency of the second object over one or more frames (e.g., including information that may be relevant for detecting whether the second object is fragmented or being tracked as multiple entities incorrectly); a tracking history of the second object (e.g., historical data points and/or tracklet history that reflects past states. which may be used to predict future states); a predicted future position of the second object (e.g., a predicted position of the second object in the next frame(s), based on current motion and dynamics); a sensor modality confidence score (e.g., confidence scores related to the specific sensor modality, such as LiDAR or camera(s), used to detect the second object in the time series sequence of frames 102); scene flow information (e.g., information about the relative 3D motion of the second object within the scene, which may aid in understanding dynamic environments); and/or optical flow information (e.g., information about the relative 2D motion of the second object within the scene, which may aid in understanding dynamic environments). Another example predicted object state associated with a second object and predicted for a particular time point may include the particular time point. For example, the particular time point may include a time point associated with a closest frame within the time series sequence of frames 102. In certain aspects, the particular time point may also be extended to include temporal context information, such as the time elapsed since the second object's last appearance or disappearance.

As described above, final state diagram 106 may be generated based on time series sequence of frames 102, such as using a motion forecasting technique. For example, in certain aspects, forward motion forecasting may be used to generate the final state diagram 106 depicted and described with respect to FIG. 1B based on the time series sequence of frames 102. FIG. 1D depicts example final state diagram generation using forward motion forecasting. As another example, in certain aspects, reverse motion forecasting may be used to generate the final state diagram 106 depicted and described with respect to FIG. 1B based on the time series sequence of frames 102. FIG. 1E depicts example final state diagram generation using reverse motion forecasting.

Specifically, as shown in FIG. 1D, final state diagram generation 150 (simply referred to herein as “generation 150”) may be used to generate final state diagram 106 from the time series sequence of frames 102, where generation 150 includes forward motion forecasting 160. Although not meant to be limiting, in this example, the time series sequence of frames 102 (simply referred to herein as “frames 102”) may include frames associated with time points T=−50 to T=50 (e.g., n=50). The frames 102 may include 101 frames (e.g., including first frame 102 associated with time point T=0), such that the time between each frame is equal to one (e.g., δ=1, such that frames 102 include a first frame associated with time T=−50, a second frame associated with time T=−49, a third frame associated with time T=−48, etc.).

To perform generation 150, only frames 102 associated with time points T=−50 to T=−1 may be used (e.g., frames associated with time points prior in time to first frame 102 shown in FIG. 1A). Using these frames 102, generation 150 may begin with dividing the frames 102 (e.g., from T=−50 to T=−1, such as including 50 frames) into multiple time series subsequences of frames 154 (simply referred to herein as “subsequences 154”). Each of the subsequences 154 may include a portion of the frames from frames 102 associated with time points T=−50 to T=−1. Each of the subsequences 154 may include consecutive frames from frames 102. In certain aspects, each of the subsequences 154 may include a same number of frames. In the example shown in FIG. 1D, the 50 frames may be broken down into forty subsequences 154. For example, a subsequence 154-1 may include eleven frames 102 associated with time points T=−50 to T=−40, a subsequence 154-2 may include another eleven frames 102 associated with time points T=−49 to T=−39, . . . and a subsequence 154-40 may include another eleven frames 102 associated with time points T=−11 to T=−11.

Creating subsequences 154 with a same number of frames may allow for more consistency in processing, especially when dealing with time series data for ML tasks. This may allow an ML model to learn patterns more uniformly across subsequences 154. However, in certain other aspects, there may be instances where each of the subsequences 154 have different amounts of frames (not shown in FIG. 1D). For example, if the data collection is irregular and/or if there are missing frames, subsequences 154 may be unequal. As another example, the size of subsequences 154 may be adjusted based on context and/or specific events (e.g., focusing more frames around an occlusion). As another example, if subsequences 154 are defined with non-overlapping windows, the remaining frames may form a smaller subsequence 154 at the end if the total number of frames is not evenly divisible.

Generation 150 then proceeds with object detection 156. Object detection 156 may include detecting one or more second objects 158 as multiple detections in each subsequence 154. A “detection” may refer to the identification and localization of an object or object state (e.g., velocity, size, orientation, heading, semantic class, etc.) in a frame of a subsequence 154. A “detection” may be associated with a time point corresponding to a frame where the detection was identified. For example, object detection 156 may be performed for subsequence 154-1 to detect one or more second objects 158-1 in frames 102 (e.g., associated with time points T=−50 to T=−40) of 154-1. As an illustrative example, a second object may be detected in frames associated with T=−50 through T=−40 (found in all frames of the subsequence 154-1). However, another second object may become occluded during frames T=−45 to T=−40; thus, the other second object may only be detected in frames associated with T=−50 to T=−46. Similarly, object detection 156 may be performed for subsequence 154-2 to detect one or more second objects 158-2 in frames 102 (e.g., associated with time points T=−49 to T=−39) of subsequence 154-2, . . . and object detection 156 may be performed for subsequence 154-40 to detect one or more second objects 158-40 in frames 102 (e.g., associated with time points T=−11 to T=−1) of subsequence 154-40.

The object states detected for one or more second objects 158 in each subsequence 154 may be represented in a respective state diagram 162 created for each subsequence 154. For example, object states (e.g., example detection) for a single object, in a frame of a subsequence, may be represented as a node in the respective state diagram 162 associated with the subsequence 154. Further, edges may be added between nodes in the respective diagram to represent relationships between objects/their object states and or between object states of a same object over time. For example, one edge may connect nodes representing object states for a second object 158 over time points associated with the subsequence 154. In certain aspects, the respective state diagram associated with each subsequence 154 is a GNN.

As an illustrative example, a state diagram 162-1 may be created for subsequence 154-1 based on object state(s) detected for second object(s) 158-1 in frames of subsequence 154-1. As shown in FIG. 1D, state diagram 162-1, may include nodes for objects and their corresponding object states at elevent time points, such as T=−50, T=−49, T=−48, T=−47, and so on until T=−40. A first node associated with T=−50 may include object state(s) detected for a second object 158-1 in a frame 102 of subsequence 154-1 associated with the time point T=−50. A second node associated with T=−50 may include object state(s) detected for another second object 158-1 in the frame 102 of subsequence 154-1 associated with the time point T=−50. Edges may be added between nodes that are predicted to be related. For example, a first node 120 associated with T=−50 may be predicted to be associated with a second node 120 associated with T=−40, such as based on similar object state(s) between the two nodes (e.g., both include the same object type, velocity, heading, etc.). In certain aspects, an edge created between a first node and a second node, where the first node is associated with an earlier time point than the second node, may represent the predicted trajectory of an object associated with the first and second nodes.

Similarly, a state diagram 162-2 may be created for subsequence 154-2, and a state diagram 162-40 may be created for subsequence 154-40.

Generation 150 then proceeds with forward motion forecasting 160. In certain aspects, forward motion forecasting 160 may be performed to predict object state(s) (e.g., including object location(s)), for one or more second objects 158 for a respective target frame associated with each subsequence 154. A respective target frame associated with each subsequence 154 may be y frames ahead of a subsequence 154.

As an illustrative example, forward motion forecasting 160 may be performed to predict object state(s) for second object(s) 158-1 at a frame 102 associated with time point T=−40 (e.g., the target frame associated with subsequence 154-1). In particular, given detected object state(s) for second objects 158-1 at frame(s) 102 associated with time points T=−50 to T=−41, forward motion forecasting 160 may be performed to predict object state(s) for second object(s) 158-1 at a frame 102 associated with time point T=−40. Similarly, forward motion forecasting 160 may be performed to predict object state(s) for second object(s) 158-2 at a frame 102 associated with time point T=−39 (e.g., the target frame associated with subsequence 154-2), . . . and forward motion forecasting 160 may be performed to predict object state(s) for second object(s) 158-40 at a frame 102 associated with time point T=−1 (e.g., the target frame associated with subsequence 154-40).

In certain aspects, for each motion forecasting prediction, there may exist (N×J) object state points, where N represents the number of second objects 158 (e.g., usually fewer than 100), and J represents the number of trajectories for each second object 158. For example, in certain aspects, four, five, and/or six trajectories (e.g., J=4, 5, or 6) may be predicted/considered for each second object 158.

The object state(s) predicted for each subsequence 154, during forward motion forecasting 160, may be added to the respective state diagram 162 for each subsequence 154.

Generation 150 then proceeds with concatenation 164. Concatenation 164 may be used to concatenate the predicted object state(s) determined for each of the subsequences 154. For example, predicted object state(s) for the target frames 102 associated with time stamp T=−40, predicted object state(s) for the target frames 102 associated with time stamp T=−39, . . . and up to predicted object state(s) for the target frames 102 associated with time stamp T=−1 may be concatenated. Concatenation of the object states may generate the final state diagram 106. Thus, the final state diagram 106 may include predicted object state(s) for second objects from T=−40 to T=−1. The final state diagram 106 may encapsulate second object 158 detections, tracklets (e.g., based on edges included in the final state diagram 106), and/or motion predictions for the second objects 158.

Different from FIG. 1D, in certain other aspects, generation 150 may be used to generate final state diagram 106 from the time series sequence of frames 102, where generation 150 includes reverse motion forecasting 180. This is depicted in FIG. 1E.

To perform generation 150 in FIG. 1E, only frames 102 associated with time points T=1 to T=50 may be used (e.g., frames associated with time points later in time to first frame 102 shown in FIG. 1A). Using these frames 102, generation 150 may begin with dividing the frames 102 (e.g., from T=1 to T=50, such as including 50 frames) into multiple time series subsequences of frames 174 (simply referred to herein as “subsequences 174”). Each of the subsequences 174 may include a portion of the frames from frames 102 associated with time points T=1 to T=50. Each of the subsequences 174 may include consecutive frames from frames 102. In certain aspects, each of the subsequences 174 may include a same number of frames. In the example shown in FIG. 1E, the 50 frames may be broken down into forty subsequences 174. For example, a subsequence 174-1 may include eleven frames 102 associated with time points T=1 to T=11, a subsequence 174-2 may include another eleven frames 102 associated with time points T=2 to T=12, . . . and a subsequence 154-40 may include another eleven frames 102 associated with time points T=40 to T=50.

Generation 150 then proceeds with object detection 156. Object detection 156 may include detecting one or more second objects 178 as multiple detections in each subsequence 174. For example, object detection 156 may be performed for subsequence 174-1 to detect one or more second objects 178-1 in frames 102 (e.g., associated with time points T=1 to T=11) of subsequence 174-1. Similarly, object detection 156 may be performed for subsequence 174-2 to detect one or more second objects 178-2 in frames 102 (e.g., associated with time points T=2 to T=12) of second subsequence 154-2, . . . and object detection 156 may be performed for subsequence 154-40 to detect one or more second objects 158-40 in frames 102 (e.g., associated with time points T=40 to T=50) of subsequence 154-40.

The object states detected for one or more second objects 178 in each subsequence 174 may be represented in a respective state diagram 182 created for each subsequence 174. As an illustrative example, a state diagram 182-1 may be created for subsequence 174-1 based on object state(s) detected for second object(s) 178-1 in frames of subsequence 174-1, a state diagram 182-2 may be created for subsequence 174-2 based on object state(s) detected for second object(s) 178-2 in frames of subsequence 174-2, . . . and a state diagram 182-40 may be created for subsequence 174-40 based on object state(s) detected for second object(s) 178-40 in frames of subsequence 174-40. In certain aspects, an edge created between a first node and a second node, where the first node is associated with an earlier time point than the second node, may represent the predicted reverse trajectory of an object associated with the first and second nodes. For example, the trajectory may be represented by right-facing arrows in a state diagram 182.

Generation 150 then proceeds with reverse motion forecasting 160. In certain aspects, forward motion forecasting 180 may be performed to predict object state(s) (e.g., including object location(s)), for one or more second objects 178 for a respective target frame associated with each subsequence 174. A respective target frame associated with each subsequence 174 may be a number of frames before a subsequence 174.

As an illustrative example, reverse motion forecasting 180 may be performed to predict object state(s) for second object(s) 178-1 at a frame 102 associated with time point T=1 (e.g., the target frame associated with subsequence 174-1). In particular, given detected object state(s) for second objects 178-1 at frame(s) 102 associated with time points T=2 to T=11, reverse motion forecasting 180 may be performed to predict object state(s) for second object(s) 178-1 at a frame 102 associated with time point T=1. Similarly, reverse motion forecasting 180 may be performed to predict object state(s) for second object(s) 178-2 at a frame 102 associated with time point T=2 (e.g., the target frame associated with subsequence 174-2), . . . and reverse motion forecasting 180 may be performed to predict object state(s) for second object(s) 178-40 at a frame 102 associated with time point T=40 (e.g., the target frame associated with subsequence 174-40).

The object state(s) predicted for each subsequence 174, during reverse motion forecasting 180, may be added to the respective state diagram 182 for each subsequence 174.

Generation 150 then proceeds with concatenation 164. Concatenation 164 may be used to concatenate the predicted object state(s) determined for each of the subsequences 174. Concatenation of the object states may generate the final state diagram 106.

Returning to FIG. 1A, using the points from the point cloud of the first frame 102 and the final state diagram 106, object detection 108 may be performed. Objection detection 108 may include processing the points from the point cloud of the first frame 104 and the final state diagram 106 to detect the one or more first objects in the first frame 104. In certain aspects, object detection 108 may consider the spatial and temporal information present in the point cloud of the first frame 104 and/or the final state diagram 106. In certain aspects, object detection 108 may include detecting the one or more first objects as multiple detections. In certain aspects, the first object(s) in the first frame 104 may be identified using one or more object detection models applied to the first frame 104 and the final state diagram 106. In certain aspects, the one or more object detection models include a multi-modal model, or more specifically, a deep learning ML model.

In certain aspects, an output of object detection 108 may include an object identity (e.g., an identifier of the object) and/or an object location (e.g., a position of the object) such as within the first frame 104.

As an example, an object location output by performing object detection 108 may represent the spatial position and/or coordinates of an object within the first frame 102. The object location may be used in (multi-object) tracking 110, as it may allow the system to determine the precise location and movement of the object across one or more frames.

In some examples, an object location may be represented using one or more bounding boxes. A bounding box may refer to a rectangular region that encloses the object of interest within a frame. The bounding box may be defined by its top-left and bottom-right coordinates and/or by its center coordinates along with its width and height.

In certain aspects, an object location may alternatively, or additionally, include information other than the bounding box coordinates. For example, the object location may include an object's center point, which may represent the centroid of the object within the first frame 104. The center point may be used for tracking the object's trajectory over time and/or for performing distance-based calculations between objects. In certain aspects, the object location may include the object's orientation and/or pose information, indicating the direction or angle at which the object is facing within the frame.

In certain aspects, at least one first object detected during object detection 108 includes an object that is occluded in the first frame 102. In certain aspects, at least one first object detected during object detection 108 includes a long object in the first frame 102.

In certain aspects, object detection 108 may include focus on a smaller number of relevant nodes, in final state diagram 106, rather than processing all data points equally. In certain aspects, this selective focus may be based on a respective weight associated with each node. This may lead to more efficient learning, particularly in scenarios with large amounts of temporal data.

After object detection 108, workflow 100 proceeds with tracking 110 in FIG. 1A. As described herein, tracking 110 may aim to estimate the trajectory(ies) of one or more objects of interest, such as the first object(s) detected during object detection 108, across successive frames. Tracking 110 may involve determining object associations across frames, such that an object is consistently tracking as it moves.

Different ML models and/or algorithms may be used for tracking 110, such as depending on the complexity and/or requirements for tracking 110. For example, in certain aspects, tracking filters, such as Kalman filters, may be used for tracking 110. A tracking filter is an algorithm used to estimate and predict the future states of objects in motion. Based on using tracking filters, objects may be tracked by estimating their future positions based on past measurements. Example tracking filters, such as Kalman filters, may be used due to their efficiency and robustness in handling noise and/or missing data for tracking 110.

As another example, in certain aspects, multi-object tracking (MOT) algorithms may be used for tracking 110. MOT algorithms may associate detected objects between frames, such as based on using Hungarian algorithms for data association and/or Intersection over Union (IoU) matching to track objects based on bounding box overlaps.

As another example, in certain aspects, deep simple online realtime tracking (DeepSORT) may be used for tracking 110. DeepSORT is a computer vision algorithm that tracks the position and movement of objects in a video sequence. DeepSORT is an extension of the simple online and realtime tracking (SORT) algorithm, which uses a Kalman filter and/or Hungarian algorithm to associate object detections across frames. DeepSORT may integrate appearance features (e.g., such as color and/or texture) using a deep neural network to help improve tracking accuracy.

As another example, in certain aspects, GNNs may be used for tracking 110, such as in more advanced systems. GNNs may be used to model the interactions between multiple objects and propagate information about their trajectories across frames. This allows for relational learning between objects, thereby helping to enhance tracking in dynamic scenes.

As another example, in certain aspects, recurrent neural networks (RNNs) may be used for tracking 110. An RNN is a type of artificial neural network that uses sequential data to make predictions. Example types of RNNs may include long short-term memory (LSTM) models and/or gated recurrent unit (GRU) models. LSTM models and/or GRU models may be used for tracking due to their ability to maintain temporal dependencies, as well as predict future trajectories by learning from a sequence of past frames.

As another example, in certain aspects, motion forecasting model(s) may be used for tracking 110. A motion forecasting model may be used to predict the future positions of detected objects based on their previous movements. A motion forecasting model may help to track objects even when occlusions occur and/or when objects leave the field of view temporarily, such as in one or more frames.

Depending on the specific implementation, a combination of the above-described methods and/or one or more additional methods, may be employed for tracking 110, such as to help achieve robust and accurate tracking across frames.

### Example Method for Object Detection and Tracking

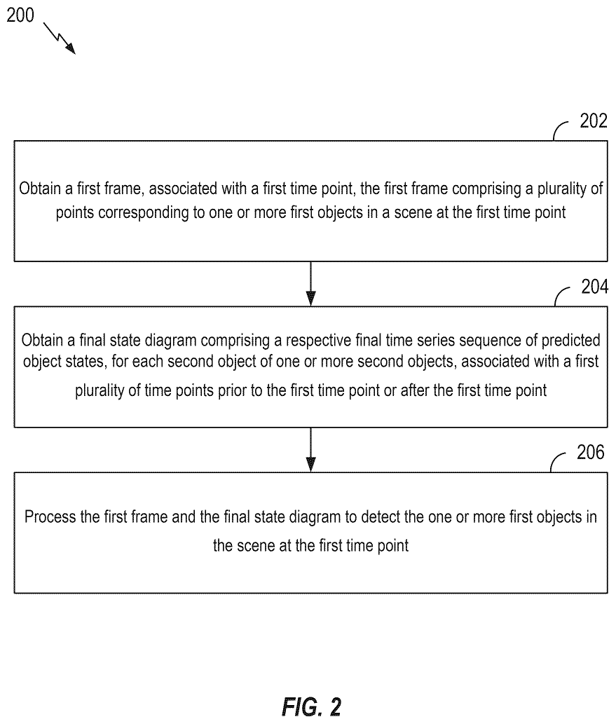

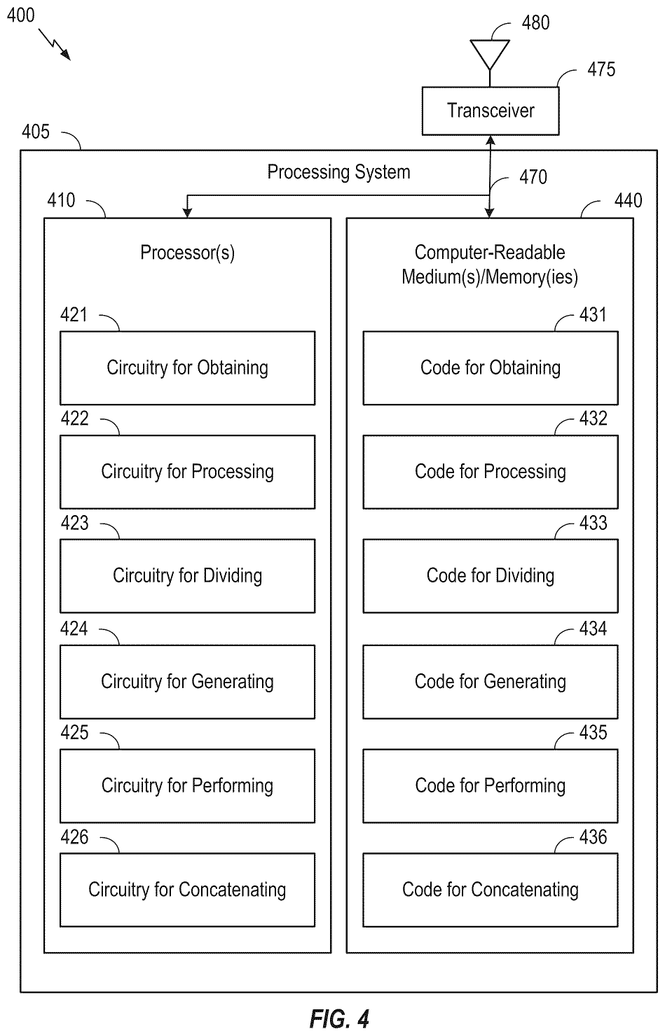

FIG. 2 depicts an example method 200 for object detection and tracking. In certain aspects, method 200, or any aspect related to it, may be performed by an apparatus, such as apparatus 400 of FIG. 4, which includes various components operable, configured, or adapted to perform the method 200.

Method 200 begins, at block 202, with obtaining a first frame, associated with a first time point, the first frame comprising a plurality of points corresponding to one or more first objects in a scene at the first time point.

Method 200 proceeds, at block 204, with obtaining a final state diagram comprising a respective final time series sequence of predicted object states, for each second object of one or more second objects, associated with a first plurality of time points prior to the first time point or after the first time point.

Method 200 proceeds, at block 206, with processing the first frame and the final state diagram to detect the one or more first objects in the scene at the first time point.

In certain aspects, each respective final time series sequence of predicted object states is represented as a respective plurality of interconnected final nodes in the final state diagram.

In certain aspects, the one or more second objects comprise at least the one or more first objects.

In certain aspects, method 200 further includes: processing the first frame and the final state diagram to detect at least one of the one or more second objects in the scene at the first time point.

In certain aspects, the final state diagram comprises a graph neural network.

In certain aspects, each respective final time series sequence of predicted object states is associated with the first plurality of time points prior to the first time point.

In certain aspects, obtaining the final state diagram, at block 204, comprises: obtaining a time series sequence of frames for the scene associated with a second plurality of time points prior to the first time point; dividing the time series sequence of frames into a plurality of time series subsequences of frames, wherein each time series subsequence of frames is associated with a respective subset of the plurality of second time points; for each time series subsequence of frames of the plurality of time series subsequences of frames: generating a respective state diagram comprising a respective time series sequence of object states for at least one second object of the one or more second objects over the respective subset of the plurality of second time points omitting a respective last time point, wherein each respective time series sequence of object states is represented as a respective plurality of interconnected nodes in the respective state diagram; and performing forward motion forecasting to determine predicted object states for the at least one second object at the respective last time point based on the respective state diagram; and concatenating the predicted object states determined for the plurality of time series subsequences of frames.

In certain aspects, each respective state diagram comprises a graph neural network.

In certain aspects, each respective final time series sequence of predicted object states is associated with the first plurality of time points after the first time point.

In certain aspects, obtaining the final state diagram, at block 204, comprises: obtaining a time series sequence of frames for the scene associated with a second plurality of time points after the first time point; dividing the time series sequence of frames into a plurality of time series subsequences of frames, wherein each time series subsequence of frames is associated with a respective subset of the second plurality of time points; for each time series subsequence of frames of the plurality of time series subsequences of frames: generating a respective state diagram comprising a respective time series sequence of object states for at least one second object of the one or more second objects over the respective subset of the second plurality of time points omitting a respective first time point, wherein each respective time series sequence of object states is represented as a respective plurality of interconnected nodes in the respective state diagram; and performing backwards motion forecasting to determine predicted object states for the at least one second object at the respective first time point based on the respective state diagram; and concatenating the predicted object states determined for the plurality of time series subsequences of frames.

In certain aspects, each respective state diagram comprises a graph neural network.

In certain aspects, processing, at block 206, the first frame and the final state diagram to detect the one or more first objects comprises: processing less than all of a respective plurality of interconnected final nodes associated with at least one respective final time series sequence of object states.

In certain aspects, the first frame comprises a sparse point cloud.

In certain aspects, each respective predicted object state of each respective final time series sequence of predicted object states associated with each respective second object comprises at least one of: a size of the respective second object; a location of the respective second object in the scene; an orientation of the respective second object; a pose estimation of the respective second object; one or more shape descriptors associated with the respective second object; one or more visual features of the respective second object; a velocity of the respective second object; an acceleration of the respective second object; a heading of the respective second object; a semantic class associated with the respective second object; a semantic class confidence score; a trajectory score associated with the respective second object; one or more confidence scores; a trajectory standard deviation; time elapsed since a last detection of the respective second object; one or more dynamics of the scene; an occlusion state of the respective second object; one or more interaction features; an environmental context; an appearance change rate; a measure of a consistency of the respective second object; a tracking history of the respective second object; a predicted future position of the respective second object; a sensor modality confidence score; scene flow information; or optical flow information.

Note that FIG. 2 is just one example of a method, and other methods including fewer, additional, or alternative steps are possible consistent with this disclosure.

### Example Sensor and Computing System for Objection Detection and Tracking

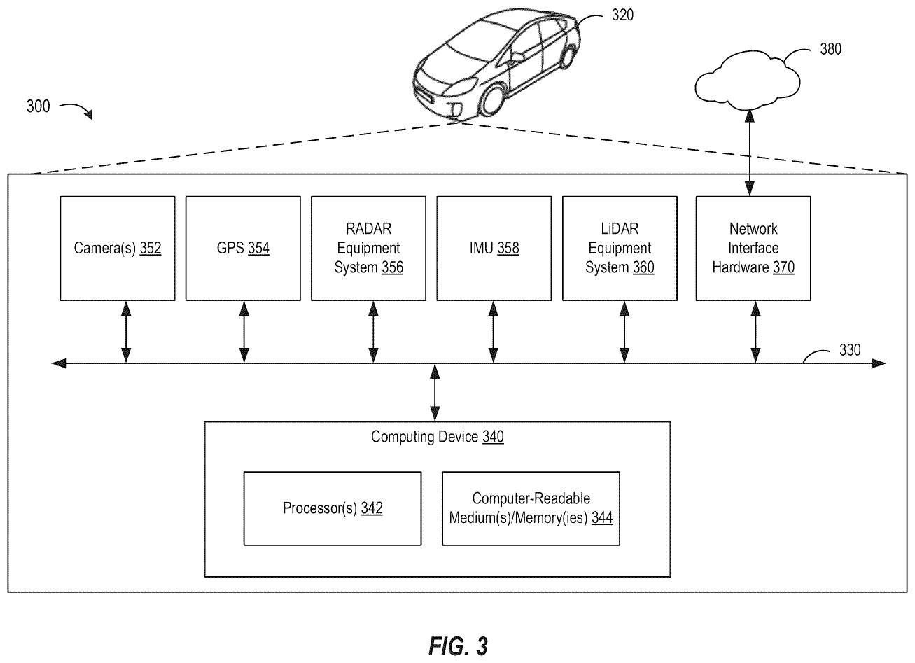

FIG. 3 depicts an example sensor and computing system 300 equipped, for example, in a vehicle 320 or other apparatus, such as a robot. The vehicle 320 depicted in FIG. 3 is depicted by way of an example schematic of a vehicle including sensor resources and a computing device. Not every vehicle may be required to be equipped with the same set of sensor resources, nor may every vehicle be required to be configured with the same set of systems for perceiving attributes of an environment. FIG. 3 only provides one example configuration of sensor resources and systems equipped within a vehicle 320. It is understood that aspects described herein are made with reference to implementation with, on, or in a vehicle 320. However, this is merely an example. The vehicle 320 may be any other apparatus.

In particular, FIG. 3 provides an example schematic of the vehicle 320 including a variety of sensor resources, which may be utilized, by the vehicle 320 to perceive and collect sensor data about the environment. For example, the vehicle 320 may include a computing device 340 comprising one or more processors 342 and one or more non-transitory computer readable medium(s)/memory(ies) 344, one or more cameras 352, a global positioning system (GPS) 354, a RADAR equipment system 356, an inertial measurement unit (IMU) 358, a LiDAR equipment system 360, and network interface hardware 370.

In certain aspects, the vehicle 320 may not include all of the components depicted in FIG. 3. In certain aspects, the vehicle 320 may include one or more of the components, such as the one or more cameras 352, the GPS 354, the RADAR equipment system 356, the IMU 358, the LiDAR equipment system 360, a SONAR system, and/or the like. These and other components of the vehicle 320 may be communicatively connected to each other via a communication path 330.

The communication path 330 may be formed from any medium that is capable of transmitting a signal such as, for example, conductive wires, conductive traces, optical waveguides, or the like. The communication path 330 may also refer to the expanse in which electromagnetic radiation and their corresponding electromagnetic waves traverses. Moreover, the communication path 330 may be formed from a combination of mediums capable of transmitting signals. In one embodiment, the communication path 330 comprises a combination of conductive traces, conductive wires, connectors, and buses that cooperate to permit the transmission of electrical data signals to components such as processors, memories, sensors, input devices, output devices, and communication devices. Accordingly, the communication path 330 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 340 may be any device or combination of components comprising one or more processors 342 and one or more non-transitory computer readable medium(s)/memory(ies) 344. The one or more processors 342 may be any device(s) capable of executing the processor-executable instructions stored in the one or more non-transitory computer readable medium(s)/memory(ies) 344. For example, each of the one or more processors 342 may be an electric controller, an integrated circuit, a microchip, a computer, or any other computing device. The one or more processors 342 are communicatively coupled to the other components of the vehicle 320 by the communication path 330. Accordingly, the communication path 330 may communicatively couple any number of processors 342 with one another, and allow the components coupled to the communication path 330 to operate in a distributed computing environment. Specifically, each of the components may operate as a node that may send and/or receive data.

The one or more non-transitory computer readable medium(s)/memory(ies) 344 may comprise RAM, ROM, flash memories, hard drives, or any non-transitory memory device capable of storing processor-executable instructions such that the processor-executable instructions can be accessed and executed by the one or more processors 342. The machine-readable instruction set may comprise logic or algorithm(s) written in any programming language of any generation (e.g., 1GL, 2GL, 3GL, 4GL, or 5GL, where GL stands for “generation language”) such as, for example, machine language that may be directly executed by the one or more processors 342, or assembly language, object-oriented programming (OOP), scripting languages, microcode, etc., that may be compiled or assembled into processor-executable instructions and stored in the one or more memories 344. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The vehicle 320 may further include one or more cameras 352. The one or more cameras 352 may be any device having an array of sensing devices (e.g., a charge-coupled device (CCD) array or active pixel sensors) capable of detecting radiation in an ultraviolet wavelength band, a visible light wavelength band, or an infrared wavelength band. The one or more cameras 352 may have any resolution. The one or more cameras 352 may be an omni-direction camera and/or a panoramic camera. In certain aspects, one or more optical components, such as a mirror, fish-eye lens, and/or any other type of lens may be optically coupled to the one or more cameras 352. The image data collected by the one or more cameras 352 may be stored in the one or more non-transitory computer readable medium(s)/memory(ies) 344.

GPS 354, may be coupled to the communication path 330 and communicatively coupled to the computing device 340 of the vehicle 320. The GPS 354 is capable of generating location information indicative of a location of the vehicle 320 by receiving one or more GPS signals from one or more GPS satellites. The GPS signal communicated to the computing device 340 via the communication path 330 may include location information including a message, a latitude and longitude data set, a street address, a name of a known location based on a location database, and/or the like. Additionally, the GPS 354 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 354 may be stored in the one or more non-transitory computer readable medium(s)/memory(ies) 344.

RADAR equipment system 356 measures the distance to objects over wide distances. It is also possible to measure the relative speed of the detected object. The RADAR equipment system 356 may be a continuous wave (CW), frequency-modulated continuous wave (FMCW), 3D-radio detection and ranging equipment (3D FMCW multiple-input and multiple-output (MIMO)), or 4D-radio detection and ranging equipment (4D FMCW MIMO). The sensor data collected by the RADAR equipment system 356 may be stored in the one or more non-transitory computer readable medium(s)/memory(ies) 344.

IMU 358 is an electronic device that measures and reports vehicle 320's specific force, angular rate, and/or the orientation of the vehicle 320, using a combination of accelerometers, gyroscopes, and/or magnetometers. The sensor data collected by the IMU 358 may be stored in one or more non-transitory computer readable medium(s)/memory(ies) 344.

LiDAR equipment system 360 is communicatively coupled to the communication path 330 and the computing device 340. LiDAR equipment system 360 may be a system and method of using pulsed laser light to measure distances from the LiDAR equipment system 360 to objects that reflect the pulsed laser light. A LiDAR equipment system 360 may be made as solid-state devices with few or no moving parts, including those configured as optical phased array devices where its prism-like operation permits a wide field-of-view without the weight and size complexities associated with a traditional rotating light detection and ranging equipment system 360. LiDAR equipment system 360 may be particularly suited to measuring time-of-flight, which in turn may be correlated to distance measurements with object(s) that are within a field-of-view of the LiDAR equipment system 360. By calculating the difference in return time of the various wavelengths of the pulsed laser light emitted by the LiDAR equipment system 360, a digital 3D representation of an object and/or or environment may be generated. The pulsed laser light emitted by the LiDAR equipment system 360 may include emissions operated in and/or near the infrared range of the electromagnetic spectrum, for example, having emitted radiation of about 905 nanometers. Vehicle 320 may use LiDAR equipment system 360 to provide detailed 3D spatial information for the identification of object(s) near the vehicle 320, as well as the use of such information in the service of systems for vehicular mapping, navigation and autonomous operations. In certain aspects, point cloud data collected by the LiDAR equipment system 360 may be stored in the one or more non-transitory computer readable medium(s)/memory(ies) 344.

In certain aspects, vehicle 320 may be equipped with a vehicle-to-vehicle (V2V) communication system, which may rely on network interface hardware 370. The network interface hardware 370 may be coupled to the communication path 330 and communicatively coupled to the computing device 340. The network interface hardware 370 may be any device capable of transmitting and/or receiving data with a network 380 and/or directly with another vehicle equipped with a V2V communication system. Accordingly, network interface hardware 370 can include a communication transceiver for sending and/or receiving any wired and/or wireless communication. For example, the network interface hardware 370 may include an antenna, a modem, a local area network (LAN) port, a Wi-Fi card, a worldwide interoperability for microwave access (WiMax) card, mobile communications hardware, near-field communication (NFC) hardware, satellite communication hardware, and/or any wired or wireless hardware for communicating with other networks and/or devices. In certain aspects, network interface hardware 370 includes hardware configured to operate in accordance with the Bluetooth wireless communication protocol. In certain aspects, network interface hardware 370 may include a Bluetooth send/receive module for sending and/or receiving Bluetooth communications to/from network 380 and/or another vehicle or device.

### Example Apparatus for Object Detection and Tracking

FIG. 4 depicts aspects of an example apparatus 400. In certain aspects, apparatus 400 is a computing device, such as computing device 340 depicted and described with respect to FIG. 3 (e.g., which may or may not be implemented by a vehicle 320).

The apparatus 400 includes a processing system 405, which may be coupled to a transceiver 475 (e.g., a transmitter and/or a receiver). The transceiver 475 is configured to transmit and receive signals for the apparatus 400 via an antenna 480, such as the various signals as described herein. The processing system 405 may be configured to perform processing functions for the apparatus 400, including processing signals received and/or to be transmitted by the apparatus 400.

The processing system 405 includes one or more processors 410. Generally, processor(s) 410 may be configured to execute computer-executable instructions (e.g., software code) to perform various functions, as described herein. The one or more processors 410 are coupled to a computer-readable medium/memory 440 via a bus 470. In certain aspects, the computer-readable medium/memory 440 is configured to store instructions (e.g., computer-executable code) that when executed by the one or more processors 410, enable and cause the one or more processors 410 to perform the method 200 described with respect to FIG. 2, or any aspect related to it, including any operations described in relation to FIGS. 1A-1E. Note that reference to a processor performing a function of the apparatus 400 may include one or more processors performing that function of the apparatus 400, such as in a distributed fashion.

In the depicted example, computer-readable medium/memory 440 stores code 431 for obtaining, code 432 for processing, code 433 for dividing, code 434 for generating, code 435 for performing, and code 436 for concatenating. Processing of the code 431-436 may enable and cause the apparatus 400 to perform the method 200 described with respect to FIG. 2, or any aspect related to it.

The one or more processors 410 include circuitry configured to implement (e.g., execute) the code stored in the computer-readable medium/memory 440, including circuitry 421 for obtaining, circuitry 422 for processing, circuitry 423 for dividing, circuitry 424 for generating, circuitry 425 for performing, and circuitry 426 for concatenating. Processing with circuitry 421-426 may enable and cause the apparatus 400 to perform the method 200 described with respect to FIG. 2, or any aspect related to it.

Apparatus 400 may be implemented in various ways. For example, apparatus 400 may be implemented within on-site, remote, or cloud-based processing equipment.

Apparatus 400 is just one example, and other configurations are possible. For example, in alternative aspects, aspects described with respect to apparatus 400 may be omitted, added, or substituted for alternative aspects.

### EXAMPLE CLAUSES

Implementation examples are described in the following numbered clauses:

Clause 1: A method for object detection and tracking, comprising: obtaining a first frame, associated with a first time point, the first frame comprising a plurality of points corresponding to one or more first objects in a scene at the first time point; obtaining a final state diagram comprising a respective final time series sequence of predicted object states, for each second object of one or more second objects, associated with a first plurality of time points prior to the first time point or after the first time point; and processing the first frame and the final state diagram to detect the one or more first objects in the scene at the first time point.

Clause 2: The method of Clause 1, wherein each respective final time series sequence of predicted object states is represented as a respective plurality of interconnected final nodes in the final state diagram.

Clause 3: The method of any one of Clauses 1-2, wherein the one or more second objects comprise at least the one or more first objects.

Clause 4: The method of any one of Clauses 1-3, further comprising: processing the first frame and the final state diagram to detect at least one of the one or more second objects in the scene at the first time point.

Clause 5: The method of any one of Clauses 1-4, wherein the final state diagram comprises a graph neural network.

Clause 6: The method of any one of Clauses 1-5, wherein each respective final time series sequence of predicted object states is associated with the first plurality of time points prior to the first time point.

Clause 7: The method of Clause 6, wherein obtaining the final state diagram comprises: obtaining a time series sequence of frames for the scene associated with a second plurality of time points prior to the first time point; dividing the time series sequence of frames into a plurality of time series subsequences of frames, wherein each time series subsequence of frames is associated with a respective subset of the plurality of second time points; for each time series subsequence of frames of the plurality of time series subsequences of frames: generating a respective state diagram comprising a respective time series sequence of object states for at least one second object of the one or more second objects over the respective subset of the plurality of second time points omitting a respective last time point, wherein each respective time series sequence of object states is represented as a respective plurality of interconnected nodes in the respective state diagram; and performing forward motion forecasting to determine predicted object states for the at least one second object at the respective last time point based on the respective state diagram; and concatenating the predicted object states determined for the plurality of time series subsequences of frames.

Clause 8: The method of Clause 7, wherein each respective state diagram comprises a graph neural network.

Clause 9: The method of any one of Clauses 1-8, wherein each respective final time series sequence of predicted object states is associated with the first plurality of time points after the first time point.

Clause 10: The method of Clause 9, wherein obtaining the final state diagram comprises: obtaining a time series sequence of frames for the scene associated with a second plurality of time points after the first time point; dividing the time series sequence of frames into a plurality of time series subsequences of frames, wherein each time series subsequence of frames is associated with a respective subset of the second plurality of time points; for each time series subsequence of frames of the plurality of time series subsequences of frames: generating a respective state diagram comprising a respective time series sequence of object states for at least one second object of the one or more second objects over the respective subset of the second plurality of time points omitting a respective first time point, wherein each respective time series sequence of object states is represented as a respective plurality of interconnected nodes in the respective state diagram; and performing backwards motion forecasting to determine predicted object states for the at least one second object at the respective first time point based on the respective state diagram; and concatenating the predicted object states determined for the plurality of time series subsequences of frames.

Clause 11: The method of Clause 10, wherein each respective state diagram comprises a graph neural network.

Clause 12: The method of any one of Clauses 1-11, wherein processing the first frame and the final state diagram to detect the one or more first objects comprises: processing less than all of a respective plurality of interconnected final nodes associated with at least one respective final time series sequence of object states.

Clause 13: The method of any one of Clauses 1-12, wherein the first frame comprises a sparse point cloud.

Clause 14: The method of any one of Clauses 1-13, wherein each respective predicted object state of each respective final time series sequence of predicted object states associated with each respective second object comprises at least one of: a size of the respective second object; a location of the respective second object in the scene; an orientation of the respective second object; a pose estimation of the respective second object; one or more shape descriptors associated with the respective second object; one or more visual features of the respective second object; a velocity of the respective second object; an acceleration of the respective second object; a heading of the respective second object; a semantic class associated with the respective second object; a semantic class confidence score; a trajectory score associated with the respective second object; one or more confidence scores; a trajectory standard deviation; time elapsed since a last detection of the respective second object; one or more dynamics of the scene; an occlusion state of the respective second object; one or more interaction features; an environmental context; an appearance change rate; a measure of a consistency of the respective second object; a tracking history of the respective second object; a predicted future position of the respective second object; a sensor modality confidence score; scene flow information; or optical flow information.

Clause 15: One or more apparatuses, comprising: one or more memories comprising executable instructions; and one or more processors configured to execute the executable instructions and cause the one or more apparatuses to perform a method in accordance with any one of clauses 1-14.

Clause 16: One or more apparatuses, comprising: one or more memories; and one or more processors, coupled to the one or more memories, configured to cause the one or more apparatuses to perform a method in accordance with any one of Clauses 1-14.

Clause 17: One or more apparatuses, comprising: one or more memories; and one or more processors, coupled to the one or more memories, configured to perform a method in accordance with any one of Clauses 1-14.

Clause 18: One or more apparatuses, comprising means for performing a method in accordance with any one of Clauses 1-14.

Clause 19: One or more non-transitory computer-readable media comprising executable instructions that, when executed by one or more processors of one or more apparatuses, cause the one or more apparatuses to perform a method in accordance with any one of Clauses 1-14.

Clause 20: One or more computer program products embodied on one or more computer-readable storage media comprising code for performing a method in accordance with any one of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising:
one or more memories; and
one or more processors, coupled to the one or more memories, configured to cause the apparatus to:
obtain a first frame, associated with a first time point, the first frame comprising a plurality of points corresponding to one or more first objects in a scene at the first time point;
obtain a final state diagram comprising a respective final time series sequence of predicted object states, for each second object of one or more second objects, associated with a first plurality of time points prior to the first time point or after the first time point; and
process the first frame and the final state diagram to detect the one or more first objects in the scene at the first time point.

2. The apparatus of claim 1, wherein each respective final time series sequence of predicted object states is represented as a respective plurality of interconnected final nodes in the final state diagram.

3. The apparatus of claim 1, wherein the one or more second objects comprise at least the one or more first objects.

4. The apparatus of claim 1, wherein the one or more processors are configured to cause the apparatus to:
process the first frame and the final state diagram to detect at least one of the one or more second objects in the scene at the first time point.

5. The apparatus of claim 1, wherein the final state diagram comprises a graph neural network.

6. The apparatus of claim 1, wherein each respective final time series sequence of predicted object states is associated with the first plurality of time points prior to the first time point.

7. The apparatus of claim 6, wherein to obtain the final state diagram, the one or more processors are configured to cause the apparatus to:
obtain a time series sequence of frames for the scene associated with a second plurality of time points prior to the first time point;
divide the time series sequence of frames into a plurality of time series subsequences of frames, wherein each time series subsequence of frames is associated with a respective subset of the plurality of second time points;
for each time series subsequence of frames of the plurality of time series subsequences of frames:
generate a respective state diagram comprising a respective time series sequence of object states for at least one second object of the one or more second objects over the respective subset of the plurality of second time points omitting a respective last time point, wherein each respective time series sequence of object states is represented as a respective plurality of interconnected nodes in the respective state diagram; and
perform forward motion forecasting to determine predicted object states for the at least one second object at the respective last time point based on the respective state diagram; and
concatenate the predicted object states determined for the plurality of time series subsequences of frames.

8. The apparatus of claim 7, wherein each respective state diagram comprises a graph neural network.

9. The apparatus of claim 1, wherein each respective final time series sequence of predicted object states is associated with the first plurality of time points after the first time point.

10. The apparatus of claim 9, wherein to obtain the final state diagram, the one or more processors are configured to cause the apparatus to:
obtain a time series sequence of frames for the scene associated with a second plurality of time points after the first time point;
divide the time series sequence of frames into a plurality of time series subsequences of frames, wherein each time series subsequence of frames is associated with a respective subset of the second plurality of time points;
for each time series subsequence of frames of the plurality of time series subsequences of frames:
generate a respective state diagram comprising a respective time series sequence of object states for at least one second object of the one or more second objects over the respective subset of the second plurality of time points omitting a respective first time point, wherein each respective time series sequence of object states is represented as a respective plurality of interconnected nodes in the respective state diagram; and
perform backwards motion forecasting to determine predicted object states for the at least one second object at the respective first time point based on the respective state diagram; and
concatenate the predicted object states determined for the plurality of time series subsequences of frames.

11. The apparatus of claim 10, wherein each respective state diagram comprises a graph neural network.

12. The apparatus of claim 1, wherein to process the first frame and the final state diagram to detect the one or more first objects, the one or more processors are configured to cause the apparatus to:
process less than all of a respective plurality of interconnected final nodes associated with at least one respective final time series sequence of object states.

13. The apparatus of claim 1, wherein the first frame comprises a sparse point cloud.

14. The apparatus of claim 1, wherein each respective predicted object state of each respective final time series sequence of predicted object states associated with each respective second object comprises at least one of:
a size of the respective second object;
a location of the respective second object in the scene;
an orientation of the respective second object;
a pose estimation of the respective second object;
one or more shape descriptors associated with the respective second object;
one or more visual features of the respective second object;
a velocity of the respective second object;
an acceleration of the respective second object;
a heading of the respective second object;
a semantic class associated with the respective second object;
a semantic class confidence score;
a trajectory score associated with the respective second object;
one or more confidence scores;
a trajectory standard deviation;
time elapsed since a last detection of the respective second object;
one or more dynamics of the scene;
an occlusion state of the respective second object;
one or more interaction features;
an environmental context;
an appearance change rate;
a measure of a consistency of the respective second object;
a tracking history of the respective second object;
a predicted future position of the respective second object;
a sensor modality confidence score;
scene flow information; or
optical flow information.

15. A method for object detection and tracking, comprising:
obtaining a first frame, associated with a first time point, the first frame comprising a plurality of points corresponding to one or more first objects in a scene at the first time point;
obtaining a final state diagram comprising a respective final time series sequence of predicted object states, for each second object of one or more second objects, associated with a first plurality of time points prior to the first time point or after the first time point; and
processing the first frame and the final state diagram to detect the one or more first objects in the scene at the first time point.

16. The method of claim 15, wherein each respective final time series sequence of predicted object states is represented as a respective plurality of interconnected final nodes in the final state diagram.

17. The method of claim 15, wherein the one or more second objects comprise at least the one or more first objects.

18. The method of claim 15, further comprising:
processing the first frame and the final state diagram to detect at least one of the one or more second objects in the scene at the first time point.

19. The method of claim 15, wherein the final state diagram comprises a graph neural network.

20. One or more non-transitory computer-readable media comprising executable instructions that, when executed by one or more processors of an apparatus, cause the apparatus to perform operations comprising:
obtaining a first frame, associated with a first time point, the first frame comprising a plurality of points corresponding to one or more first objects in a scene at the first time point;
obtaining a final state diagram comprising a respective final time series sequence of predicted object states, for each second object of one or more second objects, associated with a first plurality of time points prior to the first time point or after the first time point; and
processing the first frame and the final state diagram to detect the one or more first objects in the scene at the first time point.
